(19) United States
(12) Patent Application Publication
(10) Pub. No.: US 2025/0215953 A1
(43) Pub. Date: Jul. 3, 2025

(54) LIQUID SEAL TYPE VIBRATION ISOLATION DEVICE

(71) Applicant: Toyo Tire Corporation, Itami-shi (JP)

(72) Inventors: Tatsuki Ikawa, Itami-shi (JP); Hikofumi Yamamoto, Itami-shi (JP)

(73) Assignee: Toyo Tire Corporation, Itami-shi (JP)

(21) Appl. No.: 18/958,667

(22) Filed: Nov. 25, 2024

(30) Foreign Application Priority Data
Dec. 27, 2023 (JP) 2023-220418

(51) Int. Cl. F16F 13/10

(52) U.S. Cl. CPC F16F 13/105; F16F 2222/12; F16F 2238/04

(57) ABSTRACT

A plate portion of a switching membrane is sandwiched between a first partition plate and a second partition plate. A pair of tubular valve portions protrude from an entire circumference of a circumferential edge portion of the plate portion toward both sides in a plate thickness direction of the plate portion. An inclined surface inclined toward a side away from an opposing wall surface in a radial direction while extending toward a center in the plate thickness direction of the plate portion is formed in a circumferential surface of the switching membrane at a position including the circumferential edge portion of the plate portion.

### BACKGROUND OF THE INVENTION

### 1. Field of the Invention

The present invention relates to a liquid seal type vibration isolation device, and in particular, relates to a liquid seal type vibration isolation device capable of improving the durability of valve portions.

### 2. Description of the Related Art

As a vibration isolation device that supports a vibration source, such as an engine, on a vehicle body (support side), for example, a liquid seal type vibration isolation device disclosed in Japanese Patent Application Laid-Open (kokai) No. 2015-102168 has been known. In the liquid seal type vibration isolation device disclosed in Japanese Patent Application Laid-Open (kokai) No. 2015-102168, a liquid chamber formed inside the vibration isolation device is partitioned into a first liquid chamber and a second liquid chamber by a partition, and the first liquid chamber and the second liquid chamber communicate with each other via an orifice. The partition includes a first partition plate facing the first liquid chamber, a second partition plate facing the second liquid chamber, and a switching valve for switching between an opened state and a blocked state of the orifice.

The switching valve of Japanese Patent Application Laid-Open (kokai) No. 2015-102168 includes an annular support portion sandwiched between the first partition plate and the second partition plate, and a pair of annular (tubular) valve portions protruding from the support portion toward both sides in the axial direction. The orifice is switched from the opened state where the valve portions and an inner wall of the orifice are separated from each other to the blocked state by liquid flow in the orifice causing the entire valve portion to fall down to come into contact with the inner wall of the orifice.

In Japanese Patent Application Laid-Open (kokai) No. 2015-102168, however, when the orifice is switched from the opened state to the blocked state, one of the pair of valve portions comes into contact with the inner wall of the orifice, but the other valve portion becomes deformed so as to be separated from the inner wall and does not contribute to blocking of the orifice. The deformation of the other valve portion may decrease the durability of the valve portion.

### SUMMARY OF THE INVENTION

The present invention has been made to solve the above-described problem, and an object of the present invention is to provide a liquid seal type vibration isolation device capable of improving the durability of valve portions.

In order to achieve this object, a liquid seal type vibration isolation device according to the present invention includes: a first member and a tubular second member; a vibration-isolating base body made of an elastic body and connecting the first member and the second member; a diaphragm made of an elastic body and mounted on the second member to form a liquid chamber in which a liquid is sealed between the vibration-isolating base body and the diaphragm; a partition partitioning the liquid chamber into a first liquid chamber and a second liquid chamber; an orifice formed in the partition and providing communication between the first liquid chamber and the second liquid chamber; and a switching membrane made of an elastic body and configured to switch between an opened state and a blocked state of the orifice. The partition includes a first partition plate facing the first liquid chamber and a second partition plate facing the second liquid chamber, the orifice is formed by an annular housing space formed between the first partition plate and the second partition plate, a plurality of first through holes formed in the first partition plate so as to penetrate the first partition plate and providing communication between the first liquid chamber and the housing space, and a plurality of second through holes formed in the second partition plate so as to penetrate the second partition plate and providing communication between the second liquid chamber and the housing space, and the switching membrane includes: a plate portion having an outer circumferential edge (circumferential edge portion) facing an outer circumferential wall surface of the housing space in a radial direction over an entire circumference, and sandwiched between the first partition plate and the second partition plate such that the outer circumferential edge (circumferential edge portion) side thereof extends into the housing space; and a pair of tubular valve portions protruding from an entire circumference of the outer circumferential edge (circumferential edge portion) of the plate portion toward both sides in a plate thickness direction of the plate portion, respectively. In the opened state, each valve portion and the outer circumferential wall surface (opposing wall surface) are separated from each other, and in the blocked state, the valve portion that has been deformed radially outward (toward the opposing wall surface side in the radial direction) is brought into contact with the outer circumferential wall surface (opposing wall surface) to block the orifice. In an outer circumferential surface (circumferential surface) of the switching membrane including the outer circumferential edge (circumferential edge portion) and the outer circumferential surfaces of each valve portion, an inclined surface inclined radially inward (toward a side away from the opposing wall surface in the radial direction) while extending toward a center in the plate thickness direction of the plate portion is formed at least at a position including the outer circumferential edge (circumferential edge portion).

Another liquid seal type vibration isolation device according to the present invention includes: a first member and a tubular second member; a vibration-isolating base body made of an elastic body and connecting the first member and the second member; a diaphragm made of an elastic body and mounted on the second member to form a liquid chamber in which a liquid is sealed between the vibration-isolating base body and the diaphragm; a partition partitioning the liquid chamber into a first liquid chamber and a second liquid chamber; an orifice formed in the partition and providing communication between the first liquid chamber and the second liquid chamber; and a switching membrane made of an elastic body and configured to switch between an opened state and a blocked state of the orifice. The partition includes a first partition plate facing the first liquid chamber and a second partition plate facing the second liquid chamber, the orifice is formed by an annular housing space formed between the first partition plate and the second partition plate, a plurality of first through holes formed in the first partition plate so as to penetrate the first partition plate and providing communication between the first liquid chamber and the housing space, and a plurality of second through holes formed in the second partition plate so as to penetrate the second partition plate and providing communication between the second liquid chamber and the housing space, and the switching membrane includes: an annular plate portion having an inner circumferential edge (circumferential edge portion) facing an inner circumferential wall surface of the housing space in a radial direction over an entire circumference, and sandwiched between the first partition plate and the second partition plate such that the inner circumferential edge (circumferential edge portion) side thereof extends into the housing space; and a pair of tubular valve portions protruding from an entire circumference of the inner circumferential edge (circumferential edge portion) of the plate portion toward both sides in a plate thickness direction of the plate portion, respectively. In the opened state, each valve portion and the inner circumferential wall surface (opposing wall surface) are separated from each other, and in the blocked state, the valve portion that has been deformed radially inward (toward the opposing wall surface side in the radial direction) is brought into contact with the inner circumferential wall surface (opposing wall surface) to block the orifice. In an inner circumferential surface (circumferential surface) of the switching membrane including the inner circumferential edge (circumferential edge portion) and the inner circumferential surfaces of each valve portion, an inclined surface inclined radially outward (toward a side away from the opposing wall surface in the radial direction) while extending toward a center in the plate thickness direction of the plate portion is formed at least at a position including the inner circumferential edge (circumferential edge portion).

In the liquid seal type vibration isolation device according to the first aspect, the plate portion of the switching membrane is sandwiched between the first partition plate and the second partition plate so as to extend into the housing space forming a portion of the orifice. The circumferential edge portion (outer circumferential edge or inner circumferential edge) of the plate portion faces the opposing wall surface (outer circumferential wall surface or inner circumferential wall surface) of the housing space in the radial direction over the entire circumference. The pair of tubular valve portions protrude from the entire circumference of the circumferential edge portion of the plate portion toward both sides in the plate thickness direction of the plate portion. The switching membrane switches between the opened state where each valve portion and the opposing wall surface are separated from each other and the blocked state where the valve portion that has been deformed (fallen down) toward the opposing wall surface side in the radial direction (radially outward or radially inward) is brought into contact with the opposing wall surface to block the orifice. This radially outward deformation is caused by liquid flow in the orifice.

The inclined surface inclined toward the side away from the opposing wall surface in the radial direction (radially inward or radially outward) while extending toward the center in the plate thickness direction of the plate portion is formed in the circumferential surface of the switching membrane including the circumferential edge portion of the plate portion and the outer circumferential edge or the inner circumferential surface of each valve portion which is connected to the circumferential edge portion, at least at a position including the circumferential edge portion. Owing to this inclined surface, one of the pair of valve portions can be easily caused to fall down toward the opposing wall surface side in the radial direction independently of the other of the valve portions. Therefore, when the orifice is blocked by one of the valve portions, deformation of the other of the valve portions can be suppressed, so that the durability of the valve portions can be improved.

With a liquid seal type vibration isolation device according to a second aspect, the following effects are achieved in addition to the effects achieved by the liquid seal type vibration isolation device according to the first aspect. Of the outer circumferential surface and the inner circumferential surface of each valve portion, a surface connected to the circumferential edge portion is formed by the inclined surface, and a surface not connected to the circumferential edge portion is inclined along the inclined surface. Accordingly, the thicknesses of each valve portion can be made close to being substantially constant, so that concentration of strain on the thin portions of the valve portions can be suppressed when the valve portions fall down. As a result of these, the durability of the valve portions can be further improved.

With a liquid seal type vibration isolation device according to a third aspect, the following effects are achieved in addition to the effects achieved by the liquid seal type vibration isolation device according to the second aspect. A recess is formed on the circumferential edge portion side of the inclined surface so as to be recessed toward the side away from the opposing wall surface in the radial direction. It becomes easier for each valve portion to fall down with the recess as a fulcrum, so that it is difficult for the pair of valve portions to deform together. As a result, the durability of the valve portions can be further improved.

With a liquid seal type vibration isolation device according to a fourth aspect, the following effects are achieved in addition to the effects achieved by the liquid seal type vibration isolation device according to the third aspect. The outer circumferential surface or the inner circumferential surface of each valve portion which is not connected to the circumferential edge portion is provided with a projection portion bulged toward the side away from the opposing wall surface in the radial direction on a side opposite to the recess in the radial direction. Accordingly, even in the case where the recess is provided, the thickness of each valve portion can be made close to being substantially constant by the projection portion. As a result, a decrease in the durability of each valve portion due to concentration of strain on the vicinity of the recess during deformation of each valve portion can be suppressed.

With a liquid seal type vibration isolation device according to a fifth aspect, the following effects are achieved in addition to the effects achieved by the liquid seal type vibration isolation device according to the third aspect. The recess is formed on both the outer circumferential surface or the inner circumferential surface of the valve portion which is connected to the circumferential edge portion and the circumferential edge portion of the plate portion. Accordingly, it becomes easier for each valve portion to fall down from a base thereof, so that the time from when the valve portion starts falling down until the valve portion comes into contact with the opposing wall surface can be shortened as compared to the case where the valve portion is bent in the middle. As a result, the sensitivity of switching from the opened state to the blocked state of the orifice can be improved.

With a liquid seal type vibration isolation device according to a sixth aspect, the following effects are achieved in addition to the effects achieved by the liquid seal type vibration isolation device according to the second aspect. Each of the first through holes and the second through holes is open to the housing space at a position facing, in the radial direction, the outer circumferential surface or the inner circumferential surface of the valve portion which is not connected to the circumferential edge portion. Each of wall surfaces on the plate portion side of the first through holes and the second through holes is inclined toward the plate portion side while extending toward the opposing wall surface side in the radial direction. Accordingly, the flow of the liquid from the first through holes and the second through holes into the housing space acts almost perpendicularly on the outer circumferential surfaces or the inner circumferential surfaces of the valve portions, so that the valve portions can be quickly brought into contact with the opposing wall surface. As a result, the sensitivity of switching from the opened state to the blocked state of the orifice can be improved.

With a liquid seal type vibration isolation device according to a seventh aspect, the following effects are achieved in addition to the effects achieved by the liquid seal type vibration isolation device according to any one of the first to sixth aspects. A shortest distance from a portion of the plate portion sandwiched between the first partition plate and the second partition plate to each valve portion is equal to or less than half a length in a protrusion direction of the valve portion. Accordingly, displacement of the entire switching membrane in the plate thickness direction within the housing space by liquid flow in the orifice can be suppressed, so that only the valve portions can be easily caused to fall down.

### BRIEF DESCRIPTION OF THE DRAWINGS

FIG. 1 is a cross-sectional view of a liquid seal type vibration isolation device according to a first embodiment.

FIG. 2 is a plan view of a partition.

FIG. 3 is a plan view of the partition from which a first partition plate is detached.

FIG. 4 is a partially-enlarged cross-sectional view of the liquid seal type vibration isolation device, showing an IV part in FIG. 1 in an enlarged manner.

FIG. 5 is a partially-enlarged cross-sectional view of a liquid seal type vibration isolation device according to a second embodiment.

FIG. 6 is a partially-enlarged cross-sectional view of a liquid seal type vibration isolation device according to a third embodiment.

FIG. 7 is a partially-enlarged cross-sectional view of a partition of a liquid seal type vibration isolation device according to a fourth embodiment.

### DESCRIPTION OF THE PREFERRED EMBODIMENTS

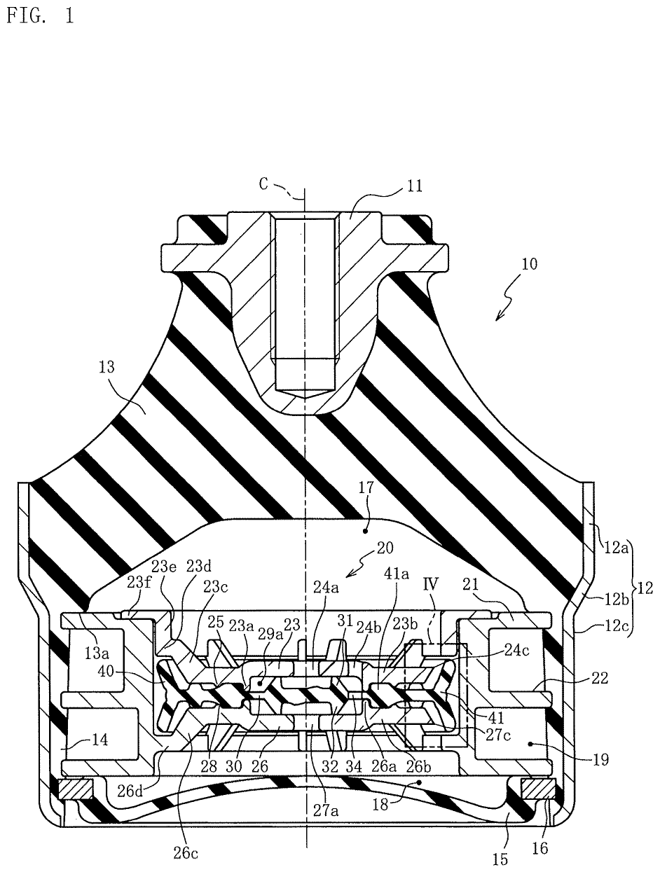

Hereinafter, preferred embodiments of the present invention will be described with reference to the accompanying drawings. FIG. 1 is a cross-sectional view of a liquid seal type vibration isolation device 10 according to a first embodiment. FIG. 1 shows a no-load state where no vibration (load) is inputted to the liquid seal type vibration isolation device 10. Unless otherwise specified, each part of the liquid seal type vibration isolation device 10 in the no-load state will be described. In the following description, the upper side of the drawing sheet of FIG. 1 is referred to as the upper side of the liquid seal type vibration isolation device 10, etc., but the upper and lower sides of the liquid seal type vibration isolation device 10 do not necessarily correspond to the upper and lower sides of a vehicle to which the liquid seal type vibration isolation device 10 is mounted.

The liquid seal type vibration isolation device 10 is an engine mount for elastically supporting an engine of an automobile. The liquid seal type vibration isolation device 10 mainly includes a first member 11 to be mounted on the engine side which is a vibration source, a tubular second member 12 to be mounted to a vehicle body which is support side, and a vibration-isolating base body 13 composed of an elastic body and connecting the first member 11 and the second member 12. The cross-sectional view of the liquid seal type vibration isolation device 10 in FIG. 1 is a cross-sectional view in the axial direction including an axis C of the tubular second member 12. The direction of the axis C is the up-down direction of the liquid seal type vibration isolation device 10. Hereinafter, a direction perpendicular to the axis C is referred to simply as radial direction, and a direction around the axis C is referred to simply as circumferential direction.

The first member 11 is a boss fitting placed on the axis C so as to be located above the second member 12, and is formed from a metal such as steel or an aluminum alloy. A bolt hole is formed in the upper end surface of the first member 11. The first member 11 is mounted on the engine side via a bolt attached to the bolt hole.

The second member 12 is a cylindrical member centered on the axis C, and is formed mainly from a metal such as steel. The second member 12 includes a large-diameter portion 12a on the upper end side, a reduced diameter portion 12b connected to the lower end of the large-diameter portion 12a and having inner and outer diameters gradually decreasing toward the lower side, and a small-diameter portion 12c connected to the lower end of the reduced diameter portion 12b having smaller inner and outer diameters than the large-diameter portion 12a. For example, the second member 12 is mounted on the vehicle body side by inserting the second member 12 into a tubular bracket provided on the vehicle body side.

The vibration-isolating base body 13 is a member made of an elastic body such as a rubber or a thermoplastic elastomer and formed in substantially the shape of an umbrella. The vibration-isolating base body 13 is vulcanized and adhered to a lower portion of the first member 11 and the inner circumferential surfaces of the large-diameter portion 12a and the reduced diameter portion 12b to connect the first member 11, the large-diameter portion 12a, and the reduced diameter portion 12b. A rubber membrane-like membrane portion 14 covering the inner circumferential surface of the small-diameter portion 12c is connected to a lower end portion of the vibration-isolating base body 13. The membrane portion 14 is a portion of the second member 12.

A diaphragm 15 is mounted to the second member 12 via a mounting part 16 so as to close the lower end opening of the small-diameter portion 12c. The diaphragm 15 is a membrane made of an elastic body such as a rubber. The mounting part 16 is an annular member made of a metal such as steel. An outer circumferential portion of the diaphragm 15 is vulcanized and adhered to an inner circumferential portion of the mounting part 16 over the entire circumference.

A liquid chamber is formed as a sealed space defined by the vibration-isolating base body 13, the second member 12, and the diaphragm 15. A nonfreezing liquid (not shown) such as ethylene glycol is sealed in the liquid chamber. The liquid chamber is partitioned by a partition 20 into a first liquid chamber 17 having a chamber wall partially formed by the vibration-isolating base body 13 and a second liquid chamber 18 having a chamber wall partially formed by the diaphragm 15.

To mount the diaphragm 15 and the partition 20 to the second member 12, first, the partition 20 is inserted into the small-diameter portion 12c of the second member 12 until coming into contact with a step 13a of the vibration-isolating base body 13 protruding radially inward from the upper end of the membrane portion 14 in a stepped manner. Next, the mounting part 16 with which the diaphragm 15 is integrated is inserted into the small-diameter portion 12c, and then the small-diameter portion 12c (second member 12) is reduced in diameter by drawing to hold outer circumferential portions of the partition 20 and the mounting part 16 by the membrane portion 14. Accordingly, the diaphragm 15 and the partition 20 are mounted to the second member 12.

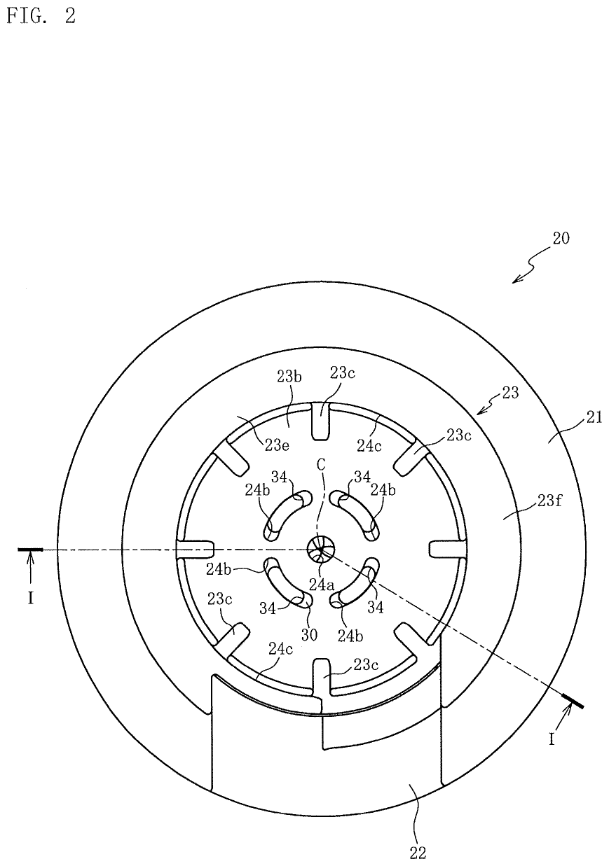

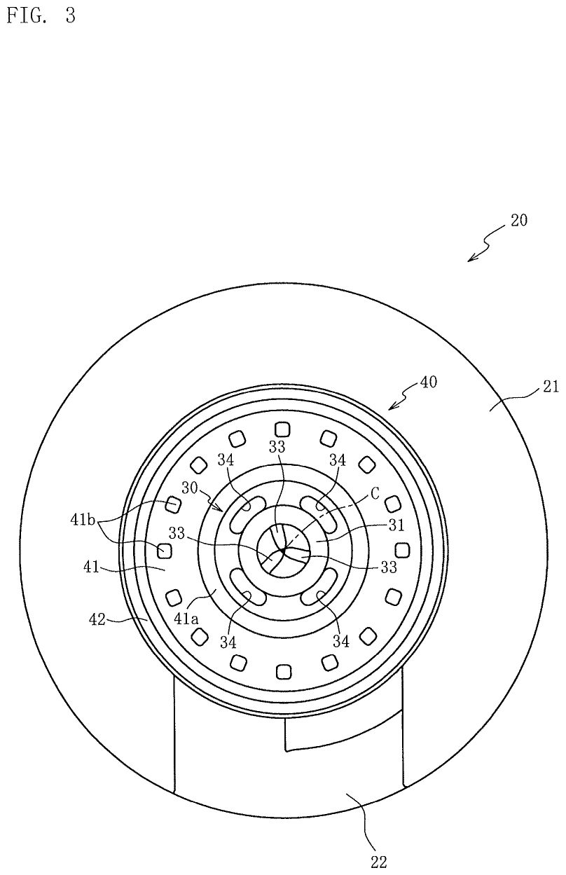

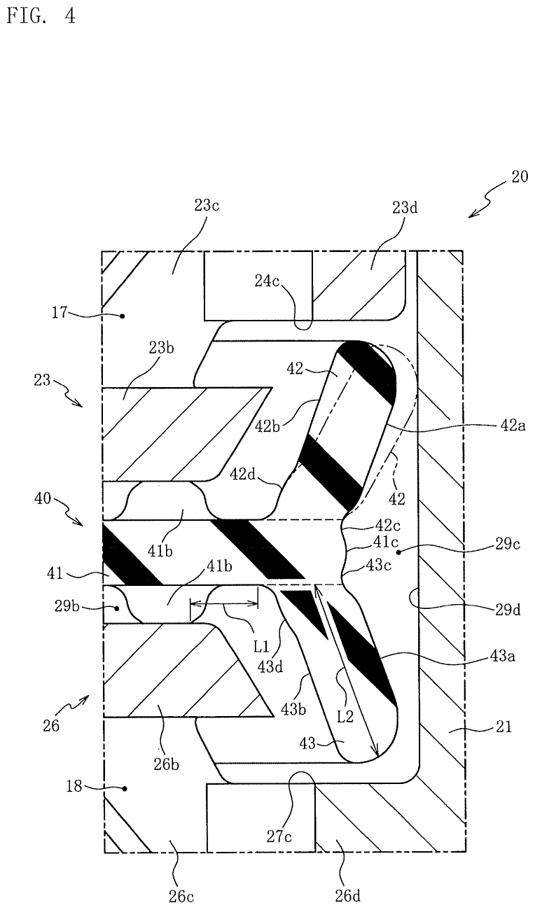

The partition 20 will be described with reference to FIG. 2 to FIG. 4 in addition to FIG. 1. FIG. 2 is a plan view of the partition 20. A cross-section of the partition 20 taken along a line I-I in FIG. 2 is shown in FIG. 1. FIG. 3 is a plan view of the partition 20 from which a first partition plate 23 is detached. FIG. 4 is a partially-enlarged cross-sectional view of the liquid seal type vibration isolation device 10, showing an IV part in FIG. 1 in an enlarged manner.

As shown in FIG. 1 and FIG. 2, the partition 20 includes a tube member 21 held inside the membrane portion 14, the first partition plate 23 and a second partition plate 26 having a flat plate shape and vertically partitioning the inner circumferential side of the tube member 21, and a valve 30 and a switching membrane 40 placed between the first partition plate 23 and the second partition plate 26. The first partition plate 23 faces the first liquid chamber 17, and the second partition plate 26 faces the second liquid chamber 18.

The tube member 21 is a cylindrical part made of a metal or a synthetic resin. The outer circumferential surface of the tube member 21 is pressed against the small-diameter portion 12c of the second member 12 via the membrane portion 14 over the entire circumference. An outer circumference groove 22 is formed on the outer circumferential surface of the tube member 21 with a length that is substantially twice the circumferential length of the tube member 21. A first orifice 19 is formed between the outer circumference groove 22 and the membrane portion 14.

The first orifice 19 communicates with the first liquid chamber 17 by one end of the outer circumference groove 22 opening to the inner circumferential surface of the tube member 21 above the first partition plate 23 or to the upper end of the tube member 21. The first orifice 19 communicates with the second liquid chamber 18 by the other end of the outer circumference groove 22 opening to the inner circumferential surface of the tube member 21 below the second partition plate 26 or to the lower end of the tube member 21.

Thus, the first orifice 19 is a flow path that provides communication between the first liquid chamber 17 and the second liquid chamber 18. For example, in order to dampen shaking vibration when the vehicle runs, the flow path cross-sectional area, the length, the cross-section circumferential length, etc., of the first orifice 19 are set such that, when shaking vibration having a large amplitude is inputted, a damping coefficient increases in a frequency band corresponding to the shaking vibration (e.g., about 5 to 15 Hz).

The first partition plate 23 is a part made of a metal or a synthetic resin, and is formed in substantially a disc shape perpendicular to the axis C. A cylindrical first tube wall 23a centered on the axis C protrudes downward (toward the second partition plate 26 side) from the lower surface of the first partition plate 23.

A plurality of holes are formed in the first partition plate 23 on the radially inner side with respect to the first tube wall 23a so as to penetrate the first partition plate 23 in the plate thickness direction thereof (up-down direction). The plurality of holes include one central hole 24a provided on the axis C and a plurality of (four in the present embodiment) first valve holes 24b provided around the central hole 24a. The plurality of first valve holes 24b are arranged in the circumferential direction.

The first partition plate 23 includes an annular plate-shaped first holding portion 23b extending radially outward from the first tube wall 23a, a plurality of (eight in the present embodiment) connection portions 23c extending radially outward and upward from the outer circumferential edge of the first holding portion 23b, and an annular outer circumferential portion 23d having an inner circumferential edge to which the connection portions 23c are connected. An annular protrusion portion 25 centered on the axis C protrudes from the lower surface of the first holding portion 23b. The protrusion portion 25 is placed at the center in the radial direction of the first holding portion 23b, and is positioned away from the first tube wall 23a and the connection portions 23c in the radial direction.

The plurality of connection portions 23c are arranged in the circumferential direction. A portion surrounded by the outer circumferential edge of the first holding portion 23b, the connection portions 23c adjacent to each other in the circumferential direction, and the inner circumferential edge of the outer circumferential portion 23d forms a first through hole 24c which penetrates the first partition plate 23. A plurality of (eight in the present embodiment) such first through holes 24c are also arranged in the circumferential direction.

A cylindrical portion 23e extends upward from the outer circumferential portion 23d, and a flange 23f extends radially outward from the upper end edge of the cylindrical portion 23e. The cylindrical portion 23e is fitted to the inner circumferential side of the tube member 21 until the flange 23f comes into contact with the upper end of the tube member 21. The first partition plate 23 is fixed to the tube member 21 by joining the flange 23f and the upper end of the tube member 21 by means of a fastening member such as a bolt, welding, adhesion, or the like.

The second partition plate 26 is a part integrally molded with the tube member 21, and is formed in substantially a disc shape perpendicular to the axis C. A cylindrical second tube wall 26a centered on the axis C protrudes upward (toward the first partition plate 23 side) from a position, on the upper surface of the second partition plate 26, facing the first tube wall 23a. The second tube wall 26a has the same inner and outer diameters as the first tube wall 23a. One second valve hole 27a is formed in the second partition plate 26 on the radially inner side with respect to the second tube wall 26a and on the axis C so as to penetrate the second partition plate 26 in the plate thickness direction thereof (up-down direction).

The second partition plate 26 includes an annular plate-shaped second holding portion 26b extending radially outward from the second tube wall 26a, a plurality of connection portions 26c extending radially outward and downward from the outer circumferential edge of the second holding portion 26b, and an annular outer circumferential portion 26d having an inner circumferential edge to which the connection portions 26c are connected. An annular protrusion portion 28 centered on the axis C protrudes from the upper surface of the second holding portion 26b. The protrusion portion 28 is placed at the center in the radial direction of the second holding portion 26b, and is positioned away from the second tube wall 26a and the connection portion 26c in the radial direction. The protrusion portion 28 and the protrusion portion 25 face each other in the axial direction.

The plurality of connection portions 26c are arranged in the circumferential direction so as to face the plurality of connection portions 23c of the first partition plate 23 in the axial direction, respectively. A portion surrounded by the outer circumferential edge of the second holding portion 26b, the connection portions 26c adjacent to each other in the circumferential direction, and the inner circumferential edge of the outer circumferential portion 26d forms a second through hole 27c which penetrates the second partition plate 26. A plurality of such second through holes 27c are also arranged in the circumferential direction so as to face the first through holes 24c in the axial direction.

As shown in FIG. 1 and FIG. 4, the outer circumferential edge of the outer circumferential portion 26d is connected to the inner circumferential surface of the tube member 21 over the entire circumference. Accordingly, a predetermined space is formed between the first partition plate 23 and the second partition plate 26. Specifically, this space includes a columnar inner space 29a provided inside the first tube wall 23a and the second tube wall 26a, an annular holding space 29b between the first holding portion 23b and the second holding portion 26b, and a housing space 29c connected to the outer circumferential side of the holding space 29b.

The inner space 29a and the first liquid chamber 17 communicate with each other via the central hole 24a and the first valve hole 24b. The inner space 29a and the second liquid chamber 18 communicate with each other via the second valve hole 27a. The housing space 29c is a space extending on both the upper and lower sides with respect to the holding space 29b, and an outer circumferential wall surface 29d is formed by the inner circumferential surface of the tube member 21. The housing space 29c and the first liquid chamber 17 communicate with each other via the first through holes 24c. The housing space 29c and the second liquid chamber 18 communicate with each other via the second through holes 27c.

As shown in FIG. 1 and FIG. 3, the valve 30 is a member composed of an elastic body such as a rubber or a thermoplastic elastomer, and is formed in a disc shape centered on the axis C. The valve 30 is housed in the inner space 29a between the first partition plate 23 and the second partition plate 26. An outer circumferential portion of the valve 30 is sandwiched between the first tube wall 23a and the second tube wall 26a over the entire circumference. This sandwiched outer circumferential portion is connected to the switching membrane 40.

The valve 30 includes a tubular valve portion 31 protruding upward from the upper surface thereof toward the first partition plate 23, a tubular valve portion 32 protruding downward from the lower surface thereof toward the second partition plate 26, and a plurality of ribs 33 reinforcing the tubular valve portions 31 and 32. A plurality of valve holes 34 are formed on the radially outer side with respect to the tubular valve portions 31 and 32 and on the radially inner side with respect to the first tube wall 23a and the second tube wall 26a so as to penetrate the valve 30 in the plate thickness direction thereof. The plurality of valve holes 34 are arranged in the circumferential direction so as to face the plurality of first valve holes 24b, respectively.

The tubular valve portions 31 and 32 are each formed in a cylindrical shape centered on the axis C. The outer circumferential surfaces of the tubular valve portions 31 and 32 are each formed in a tapered shape that is reduced in diameter toward a tip thereof. The tubular valve portion 31 and the tubular valve portion 32 are placed so as to be vertically symmetrical.

In the no-load state of the liquid seal type vibration isolation device 10, the tubular valve portion 31 is in contact with the first partition plate 23 on the radially outer side with respect to the central hole 24a and on the radially inner side with respect to the plurality of first valve holes 24b over the entire circumference. In addition, in the no-load state, the tubular valve portion 32 is in contact with the second partition plate 26 on the radially outer side with respect to the second valve hole 27a over the entire circumference. Thus, in the no-load state, the valve 30 blocks movement of the liquid between the first liquid chamber 17 and the second liquid chamber 18 via the inner space 29a.

Meanwhile, if a large load (large-amplitude vibration) is inputted to the liquid seal type vibration isolation device 10 and the pressure of the first liquid chamber 17 is made excessively negative due to deformation of the vibration-isolating base body 13, the valve 30 is displaced toward the first partition plate 23 side and the tubular valve portion 31 becomes flattened. Accordingly, the tubular valve portion 32 and the second partition plate 26 are separated from each other. As a result, the liquid flows from the second liquid chamber 18 into the first liquid chamber 17 through the second valve hole 27a, the inner space 29a, the valve holes 34, and the first valve holes 24b. Therefore, the excessive negative pressure of the first liquid chamber 17 can be eliminated, and cavitation due to the negative pressure can be suppressed. The part that functions as described above is called a cavitation valve.

When the pressure of the first liquid chamber 17 is positive, the force pushing the tubular valve portion 32 against the second partition plate 26 is merely increased, so that the valve 30 blocks movement of the liquid via the inner space 29a as in the no-load state. Furthermore, the liquid pressure from the first liquid chamber 17 is applied to the center of the valve 30 via the central hole 24a, whereby it can be made difficult for the liquid to leak through the gap between the tubular valve portion 32 and the second partition plate 26.

The ribs 33 protrude from both the upper and lower surfaces of the valve 30 on the radially inner side of the tubular valve portions 31 and 32. Furthermore, the ribs 33 extend radially from the axis C and are connected to the inner circumferential surfaces of the tubular valve portions 31 and 32. The ribs 33 can make it difficult for the tubular valve portions 31 and 32 to fall down in the radial direction. As a result, leak of the liquid through the gap between the tubular valve portion 32 and the second partition plate 26 due to falling-down of the tubular valve portions 31 and 32 can be suppressed.

As shown in FIG. 1 and FIG. 4, the switching membrane 40 is an annular member composed of an elastic body such as a rubber or a thermoplastic elastomer. The valve 30 is connected to the inner circumferential edge of the switching membrane 40 over the entire circumference. The switching membrane 40 and the valve 30 are an integrally molded product. Therefore, the productivity of the switching membrane 40 and the valve 30 can be improved as compared to the case where the switching membrane 40 and the valve 30 are molded separately and then integrated.

The switching membrane 40 includes an annular plate-shaped plate portion 41 centered on the axis C, and a pair of tube-shaped valve portions 42 and 43 protruding from the plate portion 41 toward both sides in the up-down direction (plate thickness direction thereof), respectively. The inner circumferential edge of the plate portion 41 is connected to the valve 30. In addition, in FIG. 4, the boundaries between the plate portion 41 and the valve portions 42 and 43 are shown by broken lines.

The plate portion 41 is placed in the holding space 29b over the entire circumference, and a portion thereof on an outer circumferential edge (circumferential edge portion) 41c side extends into the housing space 29c. The outer circumferential edge 41c of the plate portion 41 faces the outer circumferential wall surface (opposing wall surface) 29d of the housing space 29c in the radial direction over the entire circumference with an interval therebetween.

The plate portion 41 is formed by an annular thick portion 41a from the inner circumferential edge to substantially the center in the radial direction thereof. The thick portion 41a is formed thicker than a portion on the outer circumferential edge 41c side (other than the thick portion 41a) of the plate portion 41 in the vertical direction. The thick portion 41a is sandwiched between the first holding portion 23b and the second holding portion 26b in the axial direction. Furthermore, the thick portion 41a is housed between the first tube wall 23a and the protrusion portion 25 and between the second tube wall 26a and the protrusion portion 28. Accordingly, the switching membrane 40 is positioned in the up-down direction and the radial direction relative to the first partition plate 23 and the second partition plate 26.

A plurality of holding protrusions 41b protrude in the up-down direction from each of both the upper and lower surfaces of the plate portion 41. Each holding protrusion 41b is positioned away from the thick portion 41a toward the radially outer side (toward the outer circumferential wall surface 29d side in the radial direction). The tips of the holding protrusions 41b come into contact with the vicinities of the outer circumferential edges of the first holding portion 23b and the second holding portion 26b. The plate portion 41 is sandwiched between the first partition plate 23 and the second partition plate 26 in the vicinity of the outer circumferential edge of the holding space 29b by the holding protrusions 41b.

The plurality of (16 in the present embodiment) holding protrusions 41b are arranged in the circumferential direction around the axis C (see FIG. 3). Accordingly, fluctuations in the liquid pressure in the first liquid chamber 17 and the second liquid chamber 18 are applied to the plate portion 41 between the thick portion 41a and the holding protrusions 41b via the first through holes 24c, the second through holes 27c, the holding space 29b, and the spaces between the plurality of holding protrusions 41b. This portion of the plate portion 41 becomes deformed in response to the fluctuations in the liquid pressure, whereby vibration energy inputted to the liquid seal type vibration isolation device 10 is consumed, and the dynamic spring constant of the liquid seal type vibration isolation device 10 can be reduced.

The valve portion 42 is a conical tubular portion protruding upward and radially outward from the entire circumference of the outer circumferential edge 41c of the plate portion 41. The substantially entire outer circumferential surface of the valve portion 42 which is connected to the outer circumferential edge 41c, except for a tip portion thereof, is formed by an inclined surface 42a inclined radially inward (toward the side away from the outer circumferential wall surface 29d in the radial direction) while extending toward the center in the up-down direction of the plate portion 41. Similarly, the valve portion 43 is a conical tubular portion protruding downward and radially outward from the entire circumference of the outer circumferential edge 41c of the plate portion 41. The substantially entire outer circumferential surface of the valve portion 43 which is connected to the outer circumferential edge 41c, except for a tip portion thereof, is formed by an inclined surface 43a inclined radially inward while extending toward the center in the up-down direction of the plate portion 41.

The outer circumferential surface (circumferential surface) of the switching membrane 40 is formed by the inclined surfaces 42a and 43a (outer circumferential surfaces of the valve portions 42 and 43 connected to the outer circumferential edge 41c) and the outer circumferential edge 41c of the plate portion 41. In the no-load state, there is a gap between the outer circumferential surface of the switching membrane 40 and the outer circumferential wall surface 29d of the housing space 29c over the entire circumference. In addition, in the no-load state, there are also gaps between the tip portions of the valve portions 42 and 43 and the upper and lower wall surfaces of the housing space 29c (outer circumferential portions 23d and 26d) over the entire circumference.

These gaps in the housing space 29c, the first through holes 24c, and the second through holes 27c form a second orifice that provides communication between the first liquid chamber 17 and the second liquid chamber 18. For example, in order to reduce idle vibration during idling (when the vehicle is stopped), the flow path cross-sectional area, the length, the cross-section circumferential length, etc., of the second orifice are set such that, when idle vibration having a small amplitude is inputted, a spring constant decreases in a frequency band corresponding to the idle vibration (e.g., about 15 to 50 Hz).

When a difference in liquid pressure occurs between the first liquid chamber 17 and the second liquid chamber 18 due to application of a load to the liquid seal type vibration isolation device 10, liquid flow occurs in the second orifice. For example, when liquid flow from the first liquid chamber 17 toward the second liquid chamber 18 occurs in the second orifice, the valve portion 42 on the first liquid chamber 17 side becomes deformed so as to fall down radially outward. If the liquid pressure applied to the valve portion 42 is high, the valve portion 42 comes into contact with the outer circumferential wall surface 29d as shown by an alternate long and two short dashes line in FIG. 4, thereby blocking the second orifice. Similarly, when liquid flow from the second liquid chamber 18 toward the first liquid chamber 17 occurs in the second orifice, if the valve portion 43 becomes deformed so as to fall down radially outward and comes into contact with the outer circumferential wall surface 29d, the second orifice is blocked.

A state where the second orifice is blocked as described above is referred to as blocked state. On the other hand, a state where both of the valve portions 42 and 43 are separated from the outer circumferential wall surface 29d and the second orifice is opened is referred to as opened state. In the blocked state of the second orifice, the damping characteristics of the first orifice 19 are mainly exhibited. In the opened state of the second orifice, the damping characteristics of both the first orifice 19 and the second orifice are exhibited. That is, the damping characteristics of the liquid seal type vibration isolation device 10 are switched by switching between the opened state and the blocked state of the second orifice.

Here, if the second orifice is blocked by one of the pair of valve portions 42 and 43, the other of the valve portions 42 and 43 does not contribute to the blocking. If the other of the valve portions 42 and 43, which does not contribute, also becomes deformed significantly by liquid flow, the durability of the valve portions 42 and 43 may be decreased.

In contrast, in the present embodiment, the outer circumferential surfaces of the valve portions 42 and 43 are formed by the inclined surfaces 42a and 43a inclined radially inward while extending toward the center in the plate thickness direction of the plate portion 41, respectively. Furthermore, each of the inclined surfaces 42a and 43a is provided so as to be extended to include a portion of the outer circumferential edge 41c of the plate portion 41 in addition to the outer circumferential surface of the valve portion 42 or 43. The outer circumferential surface of the switching membrane 40 including such inclined surfaces 42a and 43a constricts radially inward in the vicinity of the plate portion 41.

Accordingly, one of the pair of valve portions 42 and 43, which are respectively located on both sides of the constriction portion, can be easily caused to fall down radially outward independently of the other of the valve portions 42 and 43. Therefore, when the second orifice is blocked by one of the valve portions 42 and 43, deformation of the other of the valve portions 42 and 43 can be suppressed, so that the durability of the valve portions 42 and 43 can be improved.

An inner circumferential surface 42b of the valve portion 42 which is not connected to the outer circumferential edge 41c is formed along the inclined surface 42a such that substantially the entirety except for a tip portion thereof is substantially parallel to the inclined surface 42a. That is, the inner circumferential surface 42b is inclined radially inward toward the plate portion 41. Similarly, an inner circumferential surface 43b of the valve portion 43 which is not connected to the outer circumferential edge 41c is formed along the inclined surface 43a such that substantially the entirety except for a tip portion thereof is substantially parallel to the inclined surface 43a. That is, the inner circumferential surface 43b is inclined radially inward toward the plate portion 41.

Accordingly, the thicknesses (dimensions in directions perpendicular to the inclined surfaces 42a and 43a) of the valve portions 42 and 43 can be made close to being substantially constant, so that concentration of strain on the thin portions of the valve portions 42 and 43 can be suppressed when the valve portions 42 and 43 fall down. As a result, the durability of the valve portions 42 and 43 can be further improved.

Since the valve portions 42 and 43 having substantially constant thicknesses extend obliquely and radially outward from the plate portion 41, the free lengths in the circumferential direction of the valve portions 42 and 43 increase toward the tip portions of the valve portions 42 and 43. In addition, when the valve portions 42 and 43 fall down radially outward, the valve portions 42 and 43 attempt to deform so as to elongate more greatly in the circumferential direction at portions closer to the tip portions of the valve portions 42 and 43. Since the original free lengths of the portions that attempt to deform so as to elongate more greatly in the circumferential direction are longer as described above, concentration of strain on parts of the valve portions 42 and 43 can be suppressed, so that the durability of the valve portions 42 and 43 can be further improved.

A recess 42c is formed on the outer circumferential edge 41c side of the inclined surface 42a so as to be recessed radially inward. Similarly, a recess 43c is formed on the outer circumferential edge 41c side of the inclined surface 43a so as to be recessed radially inward. It becomes easier for the valve portion 42 to fall down with the recess 42c as a fulcrum, and it becomes easier for the valve portion 43 to fall down with the recess 43c as a fulcrum. Therefore, it is difficult for the pair of valve portions 42 and 43 to deform together, so that the durability of the valve portions 42 and 43 can be further improved.

Furthermore, each recess 42c or 43c is formed on both the outer circumferential surface of the valve portion 42 or 43 and the outer circumferential edge 41c of the plate portion 41. Accordingly, it becomes easier for the valve portions 42 and 43 to fall down from the bases thereof (boundaries with the plate portion 41), so that the times from when the valve portions 42 and 43 start falling down until the valve portions 42 and 43 come into contact with the outer circumferential wall surface 29d can be shortened as compared to the case where the valve portions 42 and 43 are bent in the middle. As a result, the sensitivity of switching from the opened state to the blocked state of the second orifice can be improved.

The inner circumferential surface 42b of the valve portion 42 is provided with a projection portion 42d bulged radially inward on the side opposite to the recess 42c in the radial direction. The inner circumferential surface 43b of the valve portion 43 is provided with a projection portion 43d bulged radially inward on the side opposite to the recess 43c in the radial direction. Accordingly, even in the case where the recesses 42c and 43c are provided, the thicknesses of the valve portions 42 and 43 can be made close to being substantially constant by the projection portions 42d and 43d. As a result, a decrease in the durability of the valve portions 42 and 43 due to concentration of strain on the vicinities of the recesses 42c and 43c during deformation of the valve portions 42 and 43 can be suppressed.

In particular, the projection portions 42d and 43d are provided so as to extend to the tip portion sides of the valve portions 42 and 43 with respect to the positions where the recesses 42c and 43c are projected in the width directions of the valve portions 42 and 43 and extend to the boundaries with the plate portion 41. Accordingly, the free lengths in the vicinities of the projection portions 42d and 43d which mainly deform so as to elongate when the valve portions 42 and 43 fall down with the recesses 42c and 43c as fulcrums can be ensured, so that concentration of strain on the vicinities can be suppressed. Therefore, the durability of the valve portions 42 and 43 can be further improved.

A shortest distance L1 from the portion of the plate portion 41 sandwiched between the first partition plate 23 and the second partition plate 26 to each valve portion 42 or 43 is shortened by contact between the holding protrusions 41b and the first partition plate 23 and the second partition plate 26. The shortest distance LI is equal to or less than half a length L2 in the protrusion direction (direction perpendicular to the width direction) of the valve portion 42 or 43. The length L2 is the dimension from the plate portion 41 to the tip portion of the valve portion 42 or 43 at the center in the width direction of the valve portion 42 or 43.

With such a dimensional relationship, vertical bending of the plate portion 41 between the portion of the plate portion 41 sandwiched between the first partition plate 23 and the second partition plate 26 and the valve portions 42 and 43 by liquid flow in the second orifice can be suppressed. That is, displacement of the entire switching membrane 40 in the up-down direction within the housing space 29c by the liquid flow can be suppressed, so that only the valve portions 42 and 43 can be caused to fall down.

The first through holes 24c and the second through holes 27c are open to the housing space 29c at positions facing the inner circumferential surfaces 42b and 43b of the valve portions 42 and 43 in the radial direction. Therefore, the valve portions 42 and 43 can be caused to fall down in the same directions as the flow of the liquid from the first through holes 24c and the second through holes 27c into the housing space 29c. Accordingly, the valve portions 42 and 43 can be quickly brought into contact with the outer circumferential wall surface 29d, so that the sensitivity of switching from the opened state to the blocked state of the second orifice can be improved.

Furthermore, the first through holes 24c and the second through holes 27c are open to the housing space 29c at positions facing the tip portions of the valve portions 42 and 43 in the radial direction. Therefore, the liquid pressure from the first through holes 24c and the second through holes 27c is easily applied to the tip portions of the valve portions 42 and 43, so that the valve portions 42 and 43 can be easily caused to fall down from the bases thereof using the principle of leverage. As a result, the valve portions 42 and 43 can be more quickly brought into contact with the outer circumferential wall surface 29d, so that the sensitivity of switching from the opened state to the blocked state of the second orifice can be further improved.

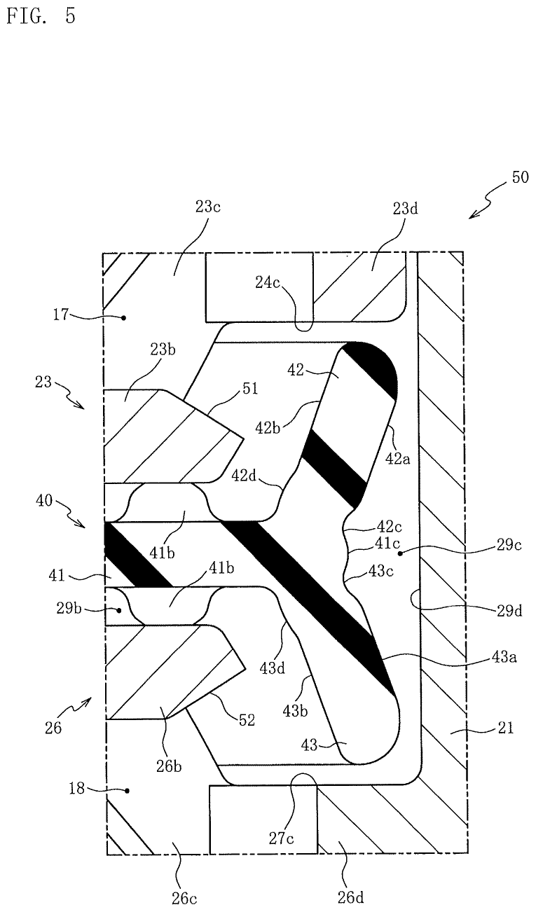

Next, a second embodiment will be described with reference to FIG. 5. In the first embodiment, the case where the wall surfaces on the plate portion 41 side of the first through holes 24c and the second through holes 27c are substantially parallel to the radial direction, has been described. Meanwhile, in the second embodiment, the case where wall surfaces 51 and 52 on the plate portion 41 side of the first through holes 24c and the second through holes 27c are inclined with respect to the radial direction, will be described. The same parts as those in the first embodiment are designated by the same reference characters, and the description thereof is omitted.

FIG. 5 is a partially-enlarged cross-sectional view of a liquid seal type vibration isolation device 50 according to the second embodiment. The cross-sectional view in FIG. 5 is a cross-sectional view at the same position as in FIG. 4. The liquid seal type vibration isolation device 50 is configured in substantially the same manner as the liquid seal type vibration isolation device 10 of the first embodiment, except for the wall surfaces 51 and 52 on the plate portion 41 side of the first through holes 24c and the second through holes 27c.

The wall surface 51 of each first through hole 24c is an outer edge portion of the upper surface of the first holding portion 23b, and is inclined toward the plate portion 41 side (lower side) while extending radially outward. The wall surface 52 of each second through hole 27c is an outer edge portion of the lower surface of the second holding portion 26b, and is inclined toward the plate portion 41 side (upper side) while extending radially outward. Accordingly, the flow of the liquid from the first through holes 24c and the second through holes 27c into the housing space 29c acts almost perpendicularly on the inner circumferential surfaces 42b and 43b of the valve portions 42 and 43, so that the valve portions 42 and 43 can be quickly brought into contact with the outer circumferential wall surface 29d. As a result, the sensitivity of switching from the opened state to the blocked state of the second orifice can be improved.

Furthermore, if an angle between the inner circumferential surface 42b and the wall surface 51 and an angle between the inner circumferential surface 43b and the wall surface 52 are within the range of 70 to 110°, the directions of the flow of the liquid from the first through holes 24c and the second through holes 27c and the inner circumferential surfaces 42b and 43b become closer to being perpendicular to each other. Therefore, the valve portions 42 and 43 can be more quickly brought into contact with the outer circumferential wall surface 29d, so that the sensitivity of switching from the opened state to the blocked state of the second orifice can be further improved.

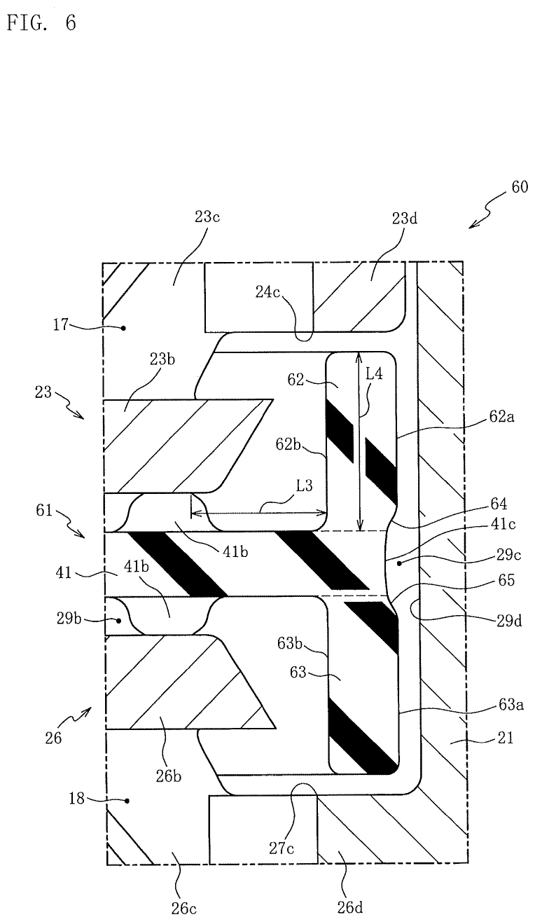

Next, a third embodiment will be described with reference to FIG. 6. In the first embodiment, the case where the valve portions 42 and 43 extend obliquely and radially outward from the plate portion 41, has been described. Meanwhile, in the third embodiment, the case where valve portions 62 and 63 rise substantially perpendicularly from the plate portion 41, will be described. The same parts as those in the first embodiment are designated by the same reference characters, and the description thereof is omitted.

FIG. 6 is a partially-enlarged cross-sectional view of a liquid seal type vibration isolation device 60 according to the third embodiment. The cross-sectional view in FIG. 6 is a cross-sectional view at the same position as in FIG. 4. The liquid seal type vibration isolation device 60 is configured in substantially the same manner as the liquid seal type vibration isolation device 10 of the first embodiment, except for a switching membrane 61.

The switching membrane 61 includes an annular plate-shaped plate portion 41, and a pair of tubular valve portions 62 and 63 protruding from the plate portion 41 toward both sides in the plate thickness direction thereof (up-down direction), respectively. In FIG. 6, the boundaries between the plate portion 41 and the valve portions 62 and 63 are shown by broken lines.

The valve portion 62 is a cylindrical portion protruding substantially perpendicularly upward from the entire circumference of the outer circumferential edge 41c of the plate portion 41. An outer circumferential surface 62a and an inner circumferential surface 62b of the valve portion 62 are parallel to each other and parallel to the up-down direction, and the thickness (dimension in the radial direction) of the valve portion 62 is substantially constant. The valve portion 63 is a cylindrical portion protruding substantially perpendicularly downward from the entire circumference of the outer circumferential edge 41c of the plate portion 41. An outer circumferential surface 63a and an inner circumferential surface 63b of the valve portion 63 are parallel to each other and parallel to the up-down direction, and the thickness (dimension in the radial direction) of the valve portion 63 is substantially constant.

In the outer circumferential surface of the switching membrane 61 including these outer circumferential surfaces 62a and 63a and the outer circumferential edge 41c of the plate portion 41, inclined surfaces 64 and 65 inclined radially inward while extending toward the center in the plate thickness direction of the plate portion 41 are formed at a position including the outer circumferential edge 41c. The inclined surface 64 is formed from a portion on the base side of the outer circumferential surface 62a to the center in the plate thickness direction of the outer circumferential edge 41c. The inclined surface 65 is formed from a portion on the base side of the outer circumferential surface 63a to the center in the plate thickness direction of the outer circumferential edge 41c. That is, the outer circumferential surface of the switching membrane 61 constricts radially inward in the vicinity of the plate portion 41 by the inclined surfaces 64 and 65.

Accordingly, in the third embodiment as well, as in the first embodiment, one the pair of valve portions 62 and 63 can be easily caused to fall down radially outward independently of the other of the valve portions 62 and 63. Therefore, when the second orifice is blocked by one of the valve portions 62 and 63, deformation of the other of the valve portions 62 and 63 can be suppressed, so that the durability of the valve portions 62 and 63 can be improved.

The inclined surfaces 64 and 65 only need to be formed at least at the outer circumferential edge 41c, and do not have to be formed in the outer circumferential surfaces 62a and 63a of the valve portions 62 and 63. In this case as well, one of the pair of valve portions 62 and 63 can be easily caused to fall down radially outward independently of the other of the valve portions 62 and 63, so that the durability of the valve portions 62 and 63 can be improved.

However, when the inclined surfaces 64 and 65 are formed up to the outer circumferential surfaces 62a and 63a, deformation of one of the pair of valve portions 62 and 63 can be easily made independent of deformation of the other of the valve portions 62 and 63. As a result, the durability of the valve portions 62 and 63 can be further improved.

In the case where the inclined surfaces 64 and 65 are formed up to the outer circumferential surfaces 62a and 63a, the projection portions 42d and 43d as in the first embodiment may be provided so as to bulge the inner circumferential surfaces 62b and 63b on the side opposite to the inclined surfaces 64 and 65 in the radial direction, although not shown. Accordingly, even in the case where the inclined surfaces 64 and 65 are provided to the valve portions 62 and 63 having substantially constant thicknesses, the thicknesses of the valve portions 62 and 63 can be kept substantially constant. As a result, a decrease in the durability of the valve portions 62 and 63 due to concentration of strain on the vicinities of the inclined surfaces 64 and 65 during deformation of the valve portions 62 and 63 can be suppressed.

A shortest distance L3 from the portion (holding protrusions 41b) of the plate portion 41 sandwiched between the first partition plate 23 and the second partition plate 26 to each valve portion 62 or 63 is equal to or less than a length L4 in the protrusion direction (up-down direction) of the valve portion 62 or 63. Accordingly, as in the first embodiment, displacement of the entire switching membrane 61 in the up-down direction within the housing space 29c by liquid flow in the second orifice can be suppressed, so that only the valve portions 62 and 63 can be easily caused to fall down.

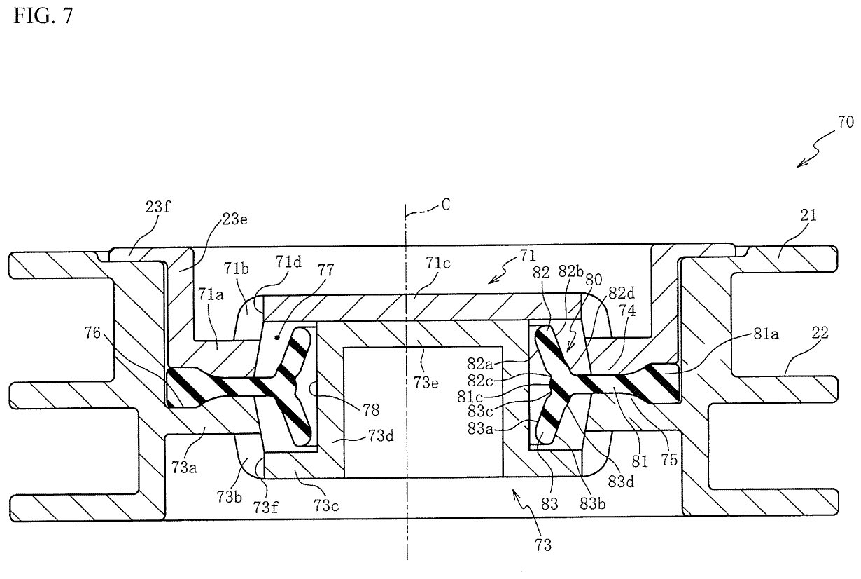

Next, a fourth embodiment will be described with reference to FIG. 7. In the first embodiment, the case where the inner circumferential edge side of the annular switching membrane 40 is sandwiched between the first partition plate 23 and the second partition plate 26, has been described. Meanwhile, in the fourth embodiment, the case where the outer circumferential edge side of an annular switching membrane 80 is sandwiched between a first partition plate 71 and a second partition plate 73, will be described. The same parts as those in the first embodiment are designated by the same reference characters, and the description thereof is omitted.

FIG. 7 is a cross-sectional view of a partition 70 of a liquid seal type vibration isolation device according to the fourth embodiment. The cross-sectional view in FIG. 7 is a cross-sectional view including the axis C. The partition 70 is assembled into the liquid seal type vibration isolation device 10 instead of the partition 20 in the first embodiment.

The partition 70 includes a tube member 21, a first partition plate 71 and a second partition plate 73 having flat plate shapes and vertically partitioning the inner circumferential side of the tube member 21, and a switching membrane 80 placed between the first partition plate 71 and the second partition plate 73. The first partition plate 71 faces the first liquid chamber 17, and the second partition plate 73 faces the second liquid chamber 18.

The first partition plate 71 is a part made of a metal or a synthetic resin, and is formed in substantially a disc shape perpendicular to the axis C. The first partition plate 71 includes an annular plate-shaped first holding portion 71a forming the outer circumferential side of the first partition plate 71, a plurality of connection portions 71b extending radially inward and upward from the inner circumferential edge of the first holding portion 71a, and a disc-shaped inner circumferential portion 71c having an outer circumferential edge to which the connection portions 71b are connected.

A cylindrical portion 23e extends upward from the outer circumferential edge of the first holding portion 71a, and a flange 23f extends radially outward from the upper end edge of the cylindrical portion 23e. An annular protrusion portion 74 centered on the axis C protrudes from the lower surface of the first holding portion 71a. The protrusion portion 74 is provided from the center in the radial direction to the inner circumferential edge of the first holding portion 71a.

The plurality of connection portions 71b are arranged in the circumferential direction. A portion surrounded by the inner circumferential edge of the first holding portion 71a, the connection portions 71b adjacent to each other in the circumferential direction, and the outer circumferential edge of the inner circumferential portion 71c forms a first through hole 71d which penetrates the first partition plate 71. A plurality of such first through holes 71d are also arranged in the circumferential direction.

The second partition plate 73 is a part integrally molded with the tube member 21, and is formed in a disc shape perpendicular to the axis C. The second partition plate 73 includes an annular plate-shaped second holding portion 73a extending radially inward from the inner circumferential surface of the tube member 21, a plurality of connection portions 73b extending radially inward and downward from the inner circumferential edge of the second holding portion 73a, an annular plate-shaped inner circumferential portion 73c having an outer circumferential edge to which the connection portions 73b are connected, a cylindrical portion 73d extending upward from the inner circumferential edge of the inner circumferential portion 73c, and a disc-shaped disc portion 73e closing the upper end of the cylindrical portion 73d. An annular protrusion portion 75 centered on the axis C protrudes from the lower surface of the second holding portion 73a. The protrusion portion 75 is provided from the center in the radial direction to the inner circumferential edge of the second holding portion 73a.

The plurality of connection portions 73b are arranged in the circumferential direction so as to face the connection portions 71b of the first partition plate 71 in the axial direction. A portion surrounded by the inner circumferential edge of the second holding portion 73a, the connection portions 73b adjacent to each other in the circumferential direction, and the outer circumferential edge of the inner circumferential portion 73c forms a second through hole 73f which penetrates the second partition plate 73. A plurality of such second through holes 73f are also arranged in the circumferential direction so as to face the first through holes 71d in the axial direction.

The first partition plate 71 and the second partition plate 73 are joined by superimposing the inner circumferential portion 71c of the first partition plate 71 on the upper surface of the disc portion 73e and welding or adhering the inner circumferential portion 71c and the disc portion 73e to each other. In this joined state, a predetermined space is formed between the first partition plate 71 and the second partition plate 73. Specifically, this space includes an annular holding space 76 between the first holding portion 71a and the second holding portion 73a, and a housing space 77 connected to the inner circumferential side of the holding space 76.

The housing space 77 is a space extending on both the upper and lower sides with respect to the holding space 76, and an inner circumferential wall surface 78 is formed by the outer circumferential surface of the cylindrical portion 73d. The housing space 77 and the first liquid chamber 17 (see FIG. 1) communicate with each other via the first through holes 71d. The housing space 77 and the second liquid chamber 18 (see FIG. 1) communicate with each other via the second through holes 73f.

The switching membrane 80 is an annular member composed of an elastic body such as a rubber or a thermoplastic elastomer. The switching membrane 80 includes an annular plate-shaped plate portion 81 centered on the axis C, and a pair of tubular valve portions 82 and 83 protruding from the plate portion 81 toward both sides in the up-down direction (plate thickness direction thereof), respectively.

The plate portion 81 is placed in the holding space 76 over the entire circumference, and a portion thereof on an inner circumferential edge (circumferential edge portion) 81cside extends into the housing space 77. The inner circumferential edge 81c of the plate portion 81 faces the inner circumferential wall surface (opposing wall surface) 78 of the housing space 77 in the radial direction over the entire circumference with an interval therebetween.

The plate portion 81 is formed by an annular thick portion 81a from the outer circumferential edge to substantially the center in the radial direction thereof. The thick portion 81a is formed thicker than a portion on the inner circumferential edge 81c side (other than the thick portion 81a) of the plate portion 81 in the vertical direction. The thick portion 81a is sandwiched between the first holding portion 71a and the second holding portion 73a in the axial direction. Furthermore, the thick portion 81a is housed between the inner circumferential surface of the tube member 21 and the protrusion portions 74 and 75, and the plate portion 81 other than the thick portion 81a is also sandwiched between the protrusion portions 74 and 75 in the axial direction. Accordingly, the switching membrane 80 fills substantially the entirety of the holding space 76 and is positioned in the up-down direction and the radial direction relative to the first partition plate 71 and the second partition plate 73.

The valve portion 82 is a conical tubular portion protruding upward and radially inward (toward the inner circumferential wall surface 78 side in the radial direction) from the entire circumference of the inner circumferential edge 81c of the plate portion 81. The valve portion 82 is a portion obtained by inverting the inner and outer sides in the radial direction of the valve portion 42 of the first embodiment. That is, an inclined surface 82a, an outer circumferential surface 82b, a recess 82c, and a projection portion 82d of the valve portion 82 are obtained by inverting the inner and outer sides of the inclined surface 42a, the inner circumferential surface 42b, the recess 42c, and the projection portion 42d of the valve portion 42, respectively.

Similarly, the valve portion 83 is a conical tubular portion protruding downward and radially inward from the entire circumference of the inner circumferential edge 81c of the plate portion 81. The valve portion 83 is a portion obtained by inverting the inner and outer sides in the radial direction of the valve portion 43 of the first embodiment. That is, an inclined surface 83a, an outer circumferential surface 83b, a recess 83c, and a projection portion 83d of the valve portion 83 are obtained by inverting the inner and outer sides of the inclined surface 43a, the inner circumferential surface 43b, the recess 43c, and the projection portion 43d of the valve portion 43, respectively.

In addition, the housing space 77, the inner circumferential wall surface 78, the first through holes 71d, the second through holes 73f, and the second orifice are also obtained by inverting the inner and outer sides in the radial direction of the housing space 29c, the outer circumferential wall surface 29d, the first through holes 24c, the second through holes 27c, and the second orifice of the first embodiment, respectively.

Therefore, the liquid seal type vibration isolation device of the fourth embodiment achieves the same effects as the liquid seal type vibration isolation device 10 of the first embodiment. For example, specifically, the inner circumferential surfaces of the valve portions 82 and 83 are formed by the inclined surfaces 82a and 83a inclined radially outward (toward the side away from the inner circumferential wall surface 78 in the radial direction) while extending toward the center in the plate thickness direction of the plate portion 81, respectively. Furthermore, each of the inclined surfaces 82a and 83a is provided so as to be extended to include a portion of the inner circumferential edge 81c of the plate portion 81 in addition to the inner circumferential surface of the valve portion 82 or 83. The inner circumferential surface (circumferential surface) of the switching membrane 80 including such inclined surfaces 82a and 83a constricts radially inward in the vicinity of the plate portion 81.

Accordingly, one of the pair of valve portions 82 and 83, which are respectively located on both sides of the constriction portion, can be easily caused to fall down radially inward independently of the other of the valve portions 82 and 83. Therefore, when the second orifice is blocked by one of the valve portions 82 and 83, deformation of the other of the valve portions 82 and 83 can be suppressed, so that the durability of the valve portions 82 and 83 can be improved.

While the present invention has been described above based on the above embodiments, the present invention is not limited to the above embodiments at all. It can be easily understood that various modifications can be made without departing from the spirit of the present invention. For example, the numbers of first through holes 24c, second through holes 27c, holding protrusions 41b, etc., may be changed as appropriate.

The first member 11 may be placed at a position offset in the radial direction from the axis C. In addition, the axis C of the second member 12 may be offset from the axis C of the valve 30, the switching membrane 40, 61, or 80, the housing space 29c or 77, etc.

The formation position, the length, etc., of the first orifice 19 may be changed as appropriate. A liquid chamber separate from the first liquid chamber 17 and the second liquid chamber 18 may be formed in the partition 20 or 70 or the like. Two liquid chambers may communicate with each other via an orifice separate from the first orifice 19. The first orifice 19 may be omitted.

A cup-shaped cap fitting may be provided at a lower portion of the diaphragm 15 (the side opposite to the first liquid chamber 17 and the second liquid chamber 18), and an air chamber may be formed by the inner surface of the cap fitting and the diaphragm 15. This air chamber may be made into a sealed space to have an air spring effect. A through hole may be provided in a portion of the cap fitting to open the air chamber to the atmosphere, and a damping effect of the air passing through the through hole may be added to the liquid seal type vibration isolation device 10, 50, or 60.

In the above embodiments, the engine mount has been described as an example of the application target of the liquid seal type vibration isolation devices 10, 50, and 60, but the application target is discretionary. Other examples of the application target include motor mounts, member mounts, and differential mounts. In addition, the present invention is not limited to the case where the first member 11 is mounted on the vibration source side such as an engine and the second member 12 is mounted on the vibration receiving side such as a vehicle body, the second member 12 may be mounted on the vibration source side, and the first member 11 may be mounted on the vibration receiving side.

In the above embodiments, the case where the vibration-isolating base body 13 forms a portion of the chamber wall of the first liquid chamber 17 and the diaphragm 15 forms a portion of the chamber wall of the second liquid chamber 18, has been described, but the present invention is not necessarily limited thereto. For example, the second liquid chamber 18 may be referred to as first liquid chamber, and the first liquid chamber 17 may be referred to as second liquid chamber.

A portion of each of the above embodiments may be omitted. For example, the membrane portion 14 may be omitted, and the partition 20 or 70 and the diaphragm 15 may be mounted on the inner circumferential surface of the second member 12. The connection portion between the valve 30 and the switching membrane 40 may be omitted, and the valve 30 and the switching membrane 40 may be independent of each other. The valve 30 and the inner space 29a may be omitted. In this case, the inner edge side of the switching membrane 40 may be closed, and the switching membrane 40 may be formed in a disc shape.

A portion of one of the above embodiments may be combined with a portion of another embodiment. For example, the valve 30, the inner space 29a, etc., in the first embodiment may be provided on the inner circumferential side of the cylindrical portion 73d in the fourth embodiment. The wall surfaces 51 and 52 of the second embodiment whose inner and outer sides in the radial direction are inverted may be provided in the fourth embodiment. The valve portions 82 and 83 in the fourth embodiment may protrude substantially perpendicularly from the plate portion 81 as in the third embodiment.

Like the protrusion portions 74 and 75 in the fourth embodiment, the protrusion portions 25 and 28 of the first embodiment, etc., may be provided up to the outer circumferential edges of the first holding portion 23b and the second holding portion 26b, and the holding protrusions 41b may be omitted. In addition, the protrusion portions 25, 28, 74, and 75 and the holding protrusions 41b may be omitted, and the thick portion 41a may be provided up to the outer circumferential edge of the holding space 29b, or the thick portion 81a may be provided up to the inner circumferential edge of the holding space 76.

In the above embodiments, the case where the plurality of holding protrusions 41b are arranged in the circumferential direction, has been described, but the present invention is not necessarily limited thereto. The holding protrusions 41b may be an annular member that is continuous over the entire circumference around the axis C. The holding protrusions 41b may be omitted.

In the above embodiments, the case where each valve portion 42, 43, 62, 63, 82, or 83 has a conical tubular shape or a cylindrical shape, has been described, but the present invention is not necessarily limited thereto, and each valve portion 42, 43, 62, 63, 82, or 83 only needs to have a tubular shape (annular shape in a cross-section perpendicular to the axis C). For example, in a cross-section perpendicular to the axis C, each valve portion 42, 43, 62, 63, 82, or 83 may have an annular shape such as a polygonal shape, an elliptical shape, and an oblong shape.

### DESCRIPTION OF REFERENCE NUMERALS

10, 50, 60 liquid seal type vibration isolation device
11 first member
12 second member
13 vibration-isolating base body
15 diaphragm
17 first liquid chamber
18 second liquid chamber
20, 70 partition
23, 71 first partition plate
24c, 71d first through hole (portion of orifice)
26, 73 second partition plate
27c, 73f second through hole (portion of orifice)
29c, 77 housing space (portion of orifice)
29d outer circumferential wall surface
40, 61, 80 switching membrane
41, 81 plate portion
41c outer circumferential edge
42, 43, 62, 63, 82, 83 valve portion
42a, 43a, 64, 65, 82a, 83a inclined surface
42b, 43b, 62b, 63b inner circumferential surface of valve portion
42c, 43c recess
42d, 43d projection portion
51, 52 wall surface
62a, 63a, 82b, 83b outer circumferential surface of valve portion
78 inner circumferential wall surface
81c inner circumferential edge

What is claimed is:

1. A liquid seal type vibration isolation device comprising:
a first member and a tubular second member;
a vibration-isolating base body made of an elastic body and connecting the first member and the second member;
a diaphragm made of an elastic body and mounted on the second member to form a liquid chamber in which a liquid is sealed between the vibration-isolating base body and the diaphragm;
a partition partitioning the liquid chamber into a first liquid chamber and a second liquid chamber;
an orifice formed in the partition and providing communication between the first liquid chamber and the second liquid chamber; and
a switching membrane made of an elastic body and configured to switch between an opened state and a blocked state of the orifice, wherein
the partition includes a first partition plate facing the first liquid chamber and a second partition plate facing the second liquid chamber,
the orifice is formed by an annular housing space formed between the first partition plate and the second partition plate, a plurality of first through holes formed in the first partition plate so as to penetrate the first partition plate and providing communication between the first liquid chamber and the housing space, and a plurality of second through holes formed in the second partition plate so as to penetrate the second partition plate and providing communication between the second liquid chamber and the housing space,
the switching membrane includes
a plate portion having a circumferential edge portion composed of either an outer circumferential edge facing an outer circumferential wall surface of the housing space in a radial direction over an entire circumference or an inner circumferential edge facing an inner circumferential wall surface of the housing space in the radial direction over the entire circumference, and sandwiched between the first partition plate and the second partition plate such that the circumferential edge portion side thereof extends into the housing space, and
a pair of tubular valve portions protruding from an entire circumference of the circumferential edge portion of the plate portion toward both sides in a plate thickness direction of the plate portion, respectively,
in the opened state, each valve portion and an opposing wall surface composed of either the outer circumferential wall surface or the inner circumferential wall surface facing the circumferential edge portion in the radial direction are separated from each other,
in the blocked state, the valve portion that has been deformed toward the opposing wall surface side in the radial direction is brought into contact with the opposing wall surface to block the orifice, and
the switching membrane has a circumferential surface including the circumferential edge portion and an outer circumferential surface or an inner circumferential surface of each valve portion which is connected to the circumferential edge portion, and an inclined surface inclined toward a side away from the opposing wall surface in the radial direction while extending toward a center in the plate thickness direction of the plate portion is formed in the circumferential surface at least at a position including the circumferential edge portion.

2. The liquid seal type vibration isolation device according to claim 1, wherein, of the outer circumferential surface and the inner circumferential surface of each valve portion, a surface connected to the circumferential edge portion is formed by the inclined surface, and a surface not connected to the circumferential edge portion is inclined along the inclined surface.

3. The liquid seal type vibration isolation device according to claim 2, wherein a recess is formed on the circumferential edge portion side of the inclined surface so as to be recessed toward the side away from the opposing wall surface in the radial direction.

4. The liquid seal type vibration isolation device according to claim 3, wherein the outer circumferential surface or the inner circumferential surface of each valve portion which is not connected to the circumferential edge portion is provided with a projection portion bulged toward the side away from the opposing wall surface in the radial direction on a side opposite to the recess in the radial direction.

5. The liquid seal type vibration isolation device according to claim 3, wherein the recess is formed on both the outer circumferential surface or the inner circumferential surface of the valve portion which is connected to the circumferential edge portion and the circumferential edge portion of the plate portion.

6. The liquid seal type vibration isolation device according to claim 2, wherein
each of the first through holes and the second through holes is open to the housing space at a position facing, in the radial direction, the outer circumferential surface or the inner circumferential surface of the valve portion which is not connected to the circumferential edge portion, and
each of wall surfaces on the plate portion side of the first through holes and the second through holes is inclined toward the plate portion side while extending toward the opposing wall surface side in the radial direction.

7. The liquid seal type vibration isolation device according to claim 1, wherein a shortest distance from a portion of the plate portion sandwiched between the first partition plate and the second partition plate to each valve portion is equal to or less than half a length in a protrusion direction of the valve portion.
